(19) United States
(12) Patent Application Publication
(10) Pub. No.: US 2010/0104131 A1
(43) Pub. Date: Apr. 29, 2010

(54) DOCUMENT PROCESSING APPARATUS AND DOCUMENT PROCESSING METHOD

(75) Inventor: Masanori Yokoi, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/604,483

(22) Filed: Oct. 23, 2009

(30) Foreign Application Priority Data
Oct. 24, 2008 (JP) 2008-274868

(51) Int. Cl. G06K 9/00

(52) U.S. Cl. 382/100

(57) ABSTRACT

Character string heights and line spacing values are acquired as character string information on a document image, and fluctuations in the character string height and fluctuations in the line spacing value are calculated as variances. If the calculated variance is equal to or lower than a threshold value, the character string information is determined as being appropriate for use in extracting line-spacing watermarks, and line-spacing watermark information is extracted from the character string information.

### BACKGROUND OF THE INVENTION

1. Field of the Invention

The present invention relates to a document processing apparatus and a document processing method and in particular relates to a document processing apparatus that extracts watermark information embedded in a document image by the use of line spacing and a document processing method.

2. Description of the Related Art

In order to invisibly include information such as copyright or copy control in a document image, methods for embedding information by slightly changing line spacing have been well-known (e.g., Kineo Matsui, “Fundamentals of Digital Watermarking-New Technology for Protection of Multimedia Contents,” Morikita Publishing Co., Ltd., p198-p199). Hereinafter, such information that has been embedded by the use of line spacing is referred to as a line-spacing watermark.

Now, the general concepts of line-spacing watermarks will be described with reference to FIG. 2. In the case of extracting information embedded as a line-spacing watermark from a document image, as a first step, the line spacing between character strings in the document image needs to be obtained. To obtain the line spacing, black-pixel-connected rectangles or character-string rectangles are generally obtained from the document image so as to derive the line spacing from the obtained character-string rectangles. Then, information is extracted based on the derived line spacing and according to the rules used at the time of embedding. As one example of such rules used at the time of embedding, for example as illustrated in FIG. 2, line spaces LS(i) and LS(i+1) are set so that LS(i)>LS(i+1) when binary information “0” are to be embedded. When binary information “1” are to be embedded, on the other hand, the line spaces LS(i) and LS(i+1) are set so that LS(i)<LS(i+1).

However, general document images often additionally include noise, addendum information, or the like as illustrated in FIG. 3 and there are also areas where the number of characters in a line is small. If such a document image is subjected to the process for obtaining character-string rectangles and acquiring line spacing, the line spacing may greatly vary depending on the area where the line spacing is acquired.

Now, taking as an example the document image illustrated in FIG. 3, a case where the character-string rectangles to be acquired vary depending on the area where the rectangles are acquired will be described. FIG. 3 illustrates an example of a document image in which a group of character strings with an embedded line-spacing watermark includes an area where the number of characters in a line is small as well as an area where addendum information has been provided or noise has occurred. FIG. 4 illustrates character-string rectangles that have been obtained from the document image in FIG. 3. Note that, in FIG. 4, the character-string rectangles are expressed filled in with black so as to be distinguished from line spacing. It can be seen from the document image in FIG. 4 that, in the case of scans A, B, and C indicated by vertical arrows, the line spacing to be acquired apparently varies depending on the area where the line spacing has been scanned, that is, the area where the line spacing has been acquired.

As is apparent from the character-string rectangles illustrated in FIG. 4, it is difficult from only acquired line-spacing information to determine whether or not a corresponding acquisition area is an inappropriate area for the acquisition of line spacing (hereinafter referred to as an “inappropriate extraction area”) such as an area including noise or addendum information or an area where the number of characters in a line is small. In addition, in the case of extracting watermark information from such an inappropriate extraction area, there is a possibility of erroneous extraction due to different line spaces.

### SUMMARY OF THE INVENTION

The present invention provides a document processing apparatus that enables high-precision extraction of line-spacing watermark information embedded in a document image and an image processing method.

According to the first aspect of the present invention, a document processing apparatus that extracts line-spacing watermark information that has been embedded by the use of line spacing from a document image, comprises: an input unit adapted to input a document image; a character string information acquisition unit adapted to acquire a character string height and a line spacing value as character string information on the document image; a fluctuation calculation unit adapted to calculate fluctuations in the character string height and fluctuations in the line spacing value; a character string information determination unit adapted to determine whether or not the character string information is appropriate for use in extracting line-spacing watermark information, based on values of the fluctuations calculated by the fluctuation calculation unit; and a watermark information extraction unit adapted to extract line-spacing watermark information from the character string information when the character string information determination unit has determined the character string information as being appropriate.

According to the second aspect of the present invention, a document processing method for extracting line-spacing watermark information embedded by use of line spacing from a document image, comprises: an input step of inputting a document image; a character string information acquisition step of acquiring a character string height and a line spacing value as character string information on the document image; a fluctuation calculation step of calculating fluctuations in the character string height and fluctuations in the line spacing value; a character string information determination step of determining whether or not the character string information is appropriate for use in extracting line-spacing watermark information, based on values of the fluctuations calculated in the fluctuation calculation step; and a watermark information extraction step of extracting line-spacing watermark information from the character string information when the character string information has been determined as being appropriate in the character string information determination step.

Further features of the present invention will be apparent from the following description of exemplary embodiments with reference to the attached drawings.

### BRIEF DESCRIPTION OF THE DRAWINGS

FIG. 1 is a block diagram illustrating a fundamental functional configuration of a document processing apparatus according to a first exemplary embodiment of the present invention.

FIG. 2 is a diagram illustrating an example of an original document in which line-spacing watermark information has been embedded.

FIG. 3 is a diagram illustrating document image data I to be processed in an exemplary embodiment of the present invention.

FIG. 4 is a diagram illustrating a rectangular image IR of the image data I.

FIG. 5 is a flow chart illustrating a procedure for extracting line-spacing watermark information according to an exemplary embodiment of the present invention.

FIG. 6 is a diagram for describing the concepts of character string information acquisition according to a second exemplary embodiment.

FIG. 7 is a diagram illustrating an example of reduced image data obtained by reducing image data horizontally and vertically according to a third exemplary embodiment.

FIG. 8 is a diagram illustrating an example of the conversion of calculated half-tone pixels into black pixels according to the third exemplary embodiment.

FIG. 9 is a diagram illustrating the concepts of scanning reduced image data according to the third exemplary embodiment.

FIG. 10 is a block diagram illustrating a basic configuration of a computer system according to a fourth exemplary embodiment.

### DESCRIPTION OF THE EMBODIMENTS

The embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Exemplary Embodiment

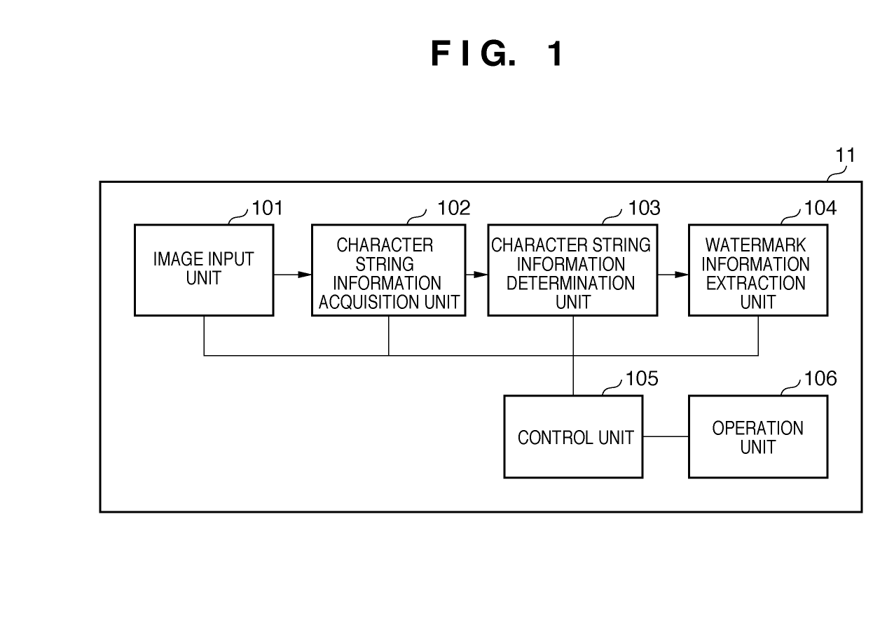

The present exemplary embodiment has the feature that it enables high-precision extraction of line-spacing watermark information that has been embedded in a document image by the use of line spacing. FIG. 1 is a block diagram illustrating a fundamental functional configuration of a document processing apparatus according to the present exemplary embodiment. As illustrated in FIG. 1, a document processing apparatus 11 according to the present exemplary embodiment includes an image input unit 101, a character string information acquisition unit 102, a character string information determination unit 103, a watermark information extraction unit 104, a control unit 105, and an operation unit 106.

The image input unit 101 reads or generates image data that is electronic data for a document image in which a line-spacing watermark has been embedded. The character string information acquisition unit 102 derives character-string rectangles from the image data and acquires character string information that includes line spaces and character string heights. The character string information determination unit 103 calculates fluctuations in the line space and fluctuations in the character string height from the acquired character string information and determines whether or not the character string information corresponds to an inappropriate extraction area such as an area including noise or addendum information or an area where the number of characters in a line is small. The watermark information extraction unit 104 extracts watermark information based on the result of the determination from the character string information determination unit 103. The control unit 105 exercises centralized control over the above-described functional units so that the functional units operate in association with each other. The operation unit 106 receives a user instruction.

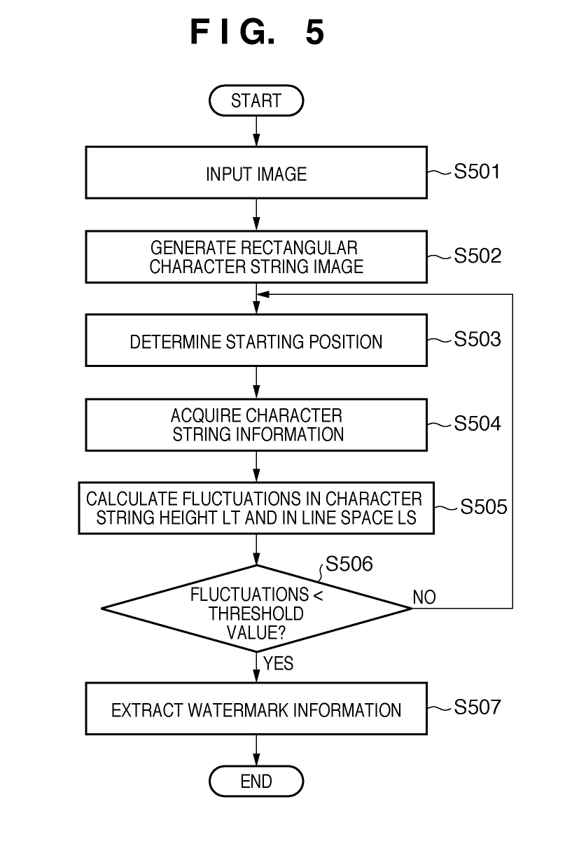

The following describes the procedure for extracting line-spacing watermark information according to the present exemplary embodiment with reference to the flow chart in FIG. 5. Note that the execution of the procedure illustrated in the flow chart in FIG. 5 is triggered by an image reading instruction that is input by a user with the operation unit 106, for example.

First, in step S501, upon the document processing apparatus 11 receiving a line spacing watermarked image, the image input unit 101 reads the line spacing watermarked image and transmits it as image data I to the character string information acquisition unit 102.

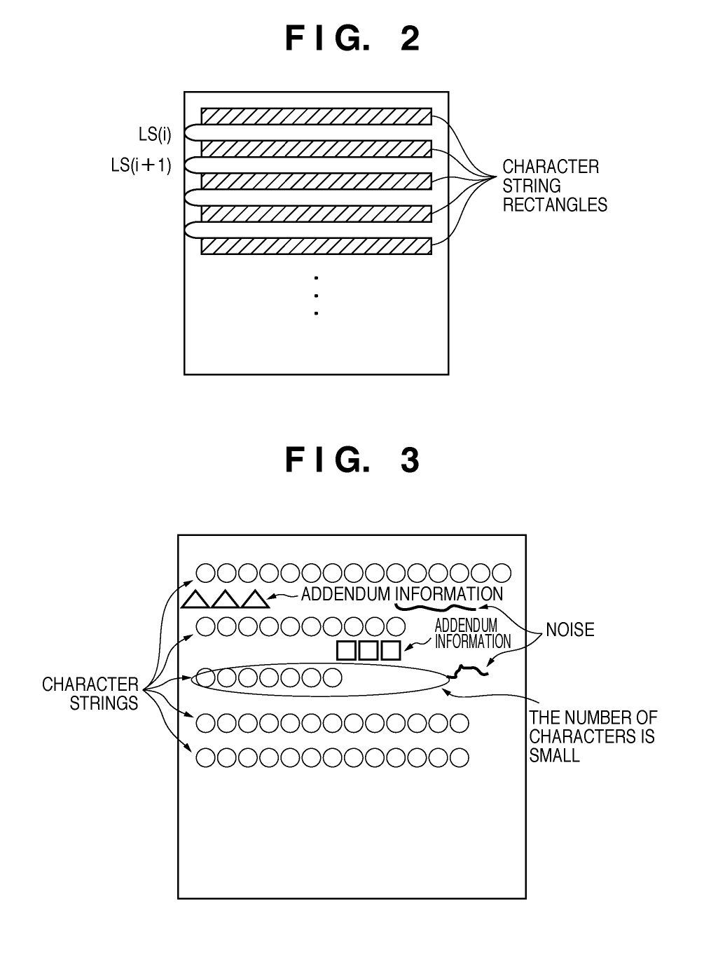

One example of the “line spacing watermarked image” as used herein is an image in which, for example as previously described with reference to FIG. 2, when the 0s of binary (0s and 1s) information are to be embedded, line spaces LS(i) and LS(i+1) are controlled so that LS(i)>LS(i+1). When the is are to be embedded, on the other hand, line spaces LS(i) and LS(i+1) are controlled so that LS(i)<LS(i+1).

Note that, in the case where the line spacing watermarked image is a paper document, the image input unit 101 inputs the document image using a charge coupled device (CCD) or an optical sensor. The image input unit 101 generates image data I through processing, such as document image capture, electric signal processing, or digital signal processing, according to an image input instruction. In the case where the image data I is processed in a data format such as PDF in the document processing apparatus 11, the image input unit 101 processes the image data I in that data format.

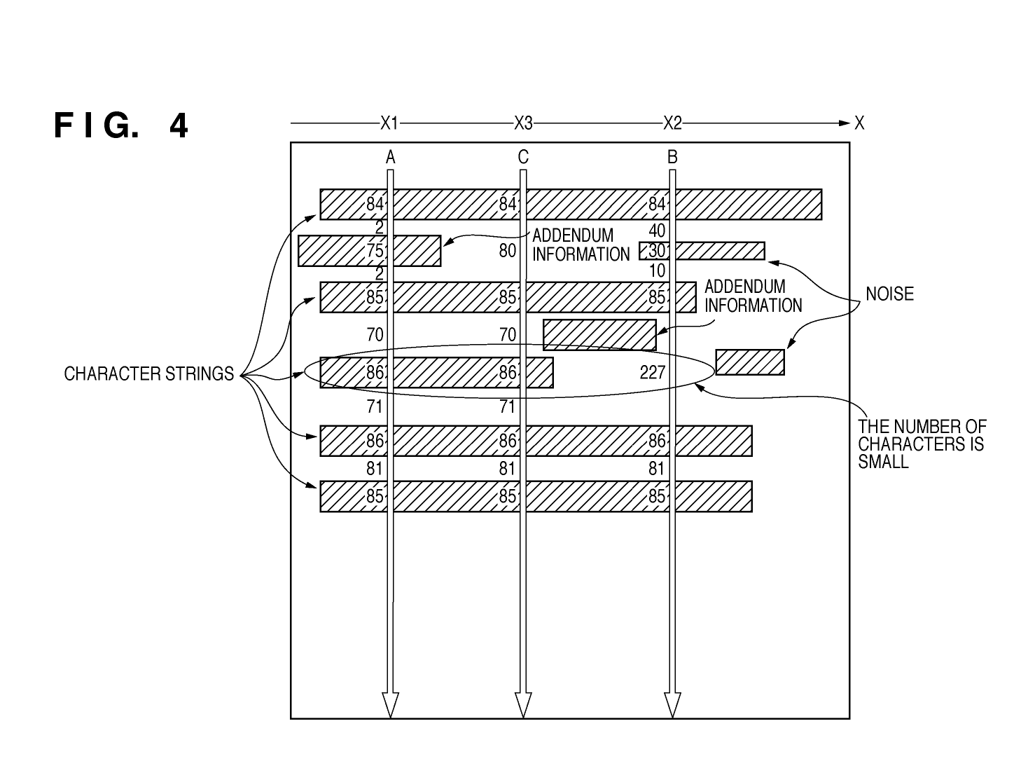

Then, in step S502, the character string information acquisition unit 102 generates a rectangular image IR from the image data I. To be more specific, the character string information acquisition unit 102 generates a rectangular image IR by sequentially scanning the image data I from the top end to specify the boundaries between black and white pixels and then by filling in regions where black pixels exist with black pixels. As described above, FIG. 4 illustrates an example of the rectangular image IR generated from the image data I illustrated in FIG. 3; it is apparent from FIG. 4 that noise and addendum information are also included as character-string rectangles in the rectangular image IR.

Note that the method for generating a rectangular image IR is not limited to this example. For example, character region segmentation techniques generally well-known in the character recognition techniques may be applicable, such as a method for generating character-string rectangles by specifying character-string regions from the density of black pixels per unit area.

Thereafter, in step S503, the character string information acquisition unit 102 determines a starting position X of a character string information acquisition area in the rectangular image IR. Then, in step S504, the character string information acquisition unit 102 acquires character string information LI from the rectangular image IR in accordance with the starting position X and transmits the acquired character string information LI to the character string information determination unit 103.

The “character string information” LI as used herein refers to a data arrangement of the rectangular character string image IR in which character string heights LT (black pixel portions in FIG. 4) and line spaces LS (white pixel portions in FIG. 4) are stored in sequence. Such character string information LI is obtained by a scan performed from the starting position X (X1, X2, or X3 in FIG. 4) in the direction orthogonal to the direction in which the character strings extend, such as the scans A, B, and C in FIG. 4. For example, in the case of the scan A illustrated in FIG. 4, the values of 84, 75, 85, 86, 86, and 85 are obtained as the character string heights LT and the values of 2, 3, 70, 71, and 81 are obtained as the line spaces LS. Here, the character string heights LT and the line spaces LS are expressed in units of pixels.

Note that the method for determining an area of the rectangular image IR from which the character string information is acquired, that is, the starting position X that is the main-scanning coordinate for the scans A, B, and C illustrated in FIG. 4 is not in particular limited. For example, the rectangular image IR may be scanned sequentially at a predetermined constant interval at the time of extraction, or three areas at the right, central, and left portions of the rectangular image IR may be scanned, or the rectangular image IR may be scanned at random.

Then, in step S505, the character string information determination unit 103 determines fluctuations in the character string height LT and fluctuations in the line space LS separately based on the character string information LI transmitted from the character string information acquisition unit 102.

This is because the present exemplary embodiment is based on the following characteristic. Specifically, in the case where the character string information is acquired from an area that does not include an area where the number of characters is small and that is constituted by only the same character strings and the same line spaces at the time of embedding, there will be small fluctuations in the character string height LT (black pixel portion in FIG. 4) and in the line space LS (white pixel portion in FIG. 4). On the contrary, if the character string information is acquired from an inappropriate extraction area that can be the cause of erroneous extraction of line-spacing watermark information, such as an area including noise or addendum information or an area where the number of characters is small, there will be large fluctuations in the character string height LT and in the line space LS.

In view of this, according to the present exemplary embodiment, it is determined whether or not a scan by which the character string information has been acquired includes an inappropriate extraction area that can be the cause of erroneous extraction of line-spacing watermark information, such as an area including noise or addendum information or an area where the number of characters is small. Thereafter, line-spacing watermark information is extracted by a scan that does not include an inappropriate extraction area, that is, from the character string information that has been obtained from a target extraction area, which enables an improvement in the precision of line-spacing watermark information extraction.

The following description of the present exemplary embodiment provides an example where the above-described fluctuations in the character string height LT and fluctuations in the line space LS are obtained using a variance; however, a standard deviation may be used instead of a variance.

For example if there are n pieces of data xᵢ (i=1 to n), their variance σ² is expressed using an average xₐᵥₑ of those pieces of data, as follows.

$${σ}^{2} = \frac{1}{n} {\sum }_{i = 1}^{N} {( {x}_{ave} - {x}_{i} )}^{2} \qquad ( 1 )$$

In step S505, the character string information determination unit 103 calculates the variance in the character string heights LT and the variance in the line spaces LS from the above expression (1). Then, in step S506, the character string information determination unit 103 determines whether or not the character string information acquisition area is an inappropriate extraction area, based on the result of the variances calculated in step S505. As one example of this determination method, for example, a predetermined threshold value T and the variance is compared with the threshold value T. Specifically, if the variance is equal to or higher than the threshold value T, the character string information acquisition area is determined as being an inappropriate extraction area. On the contrary, if the variance is lower than the threshold value T, the character string information acquisition area is determined as not being an inappropriate extraction area, that is, as being a target extraction area. Note that the threshold value T may be a prescribed fixed value, or a variance in an inappropriate extraction area may be calculated at the time of embedding watermark information and the calculated results may be used as the threshold value T at the time of extraction.

The following describes a specific example of the process for calculating a variance and determining an inappropriate extraction area based on the variance performed by the character string information determination unit 103 (steps S505 and S506).

Assume for example that, as illustrated in FIG. 4, the character string information acquisition unit 102 has obtained, as the character string information LI, the character string heights LT and the line spaces LS as follows through Scan A (starting position X1). Note that LT and LS are expressed in units of pixels.

LT(1)=84, LT(2)=75, LT(3)=85, LT(4)=86, LT(5)=86, LT(6)=85

LS(1)=2, LS(2)=3, LS(3)=70, LS(4)=71, LS(5)=81

In this case, the variance in the character string heights LT and the variance in the line spaces LS are calculated at 14.9 and 1241.8, respectively, from the expression (1). If T=30, Scan A is determined as having scanned an inappropriate extraction area since the variance in the line spaces LS is higher than T although the variance in the character string heights LT is lower than T. The result of the determination is then transmitted to the character string information acquisition unit 102. It can be seen from FIG. 4 that Scan A includes an area that includes addendum information.

Upon receiving the result of the determination from the character string information determination unit 103, the character string information acquisition unit 102 determines a new scanning starting position, obtains the character string information LI from the new starting position, and transmits the obtained information to the character string information determination unit 103.

Next, assuming that Scan B (starting position X2) in FIG. 4 has obtained the character string heights LT and the line spaces LS as follows, as the character string information LI:

LT(1)=84,LT(2)=30,LT(3)=85,LT(4)=86,LT(5)=85,

LS(1)=40,LS(2)=10,LS(3)=227,LS(4)=81

From the expression (1), the variance in the character string heights LT and the variance in the line spaces LS are calculated at 484.4 and 6937.3, respectively. Since T=30 and because both LT and LS are higher than T, as in the case of Scan A, Scan B is also determined as having scanned an inappropriate extraction area, and the result of the determination is transmitted to the character string information acquisition unit 102. It can be seen from FIG. 4 that Scan B includes an area where the number of characters is small.

Similarly, assuming that Scan C (starting position X3) in FIG. 4 has obtained the character string heights LT and the line spaces LS as follows, as the character string information LI:

LT(1)=84,LT(2)=85,LT(3)=86,LT(4)=86,LT(5)=85,

LS(1)=80,LS(2)=70,LS(3)=71,LS(4)=81

From the expression (1), the variance in the character string heights LT and the variance in the line spaces LS are calculated at 0.6 and 25.3, respectively. Since T=30 and because both of LT and LS are lower than T, Scan C is determined as not including an inappropriate extraction area, that is, as having scanned a target extraction area, and the character string information LI is transmitted to the watermark information extraction unit 104.

As described above, if the fluctuations are large, that is, the character string information acquisition area is an inappropriate extraction area, in step S506, the process returns to step S503 and performs another scan from a new starting position. On the other hand, if the fluctuations are small, that is, the character string information acquisition area is a target extraction area, the process goes to step S507.

In step S507, the watermark information extraction unit 104 extracts embedded line-spacing watermark information, using the line spaces LS in the character string information LI transmitted from the character string information determination unit 103.

Note that the extraction of the line-spacing watermark information in step S507 is performed according to the rules used at the time of embedding the information. For example, as described above, if the line spaces are LS(i) and LS(i+1) (where i=1, 3, 5, . . . , and N−1), the line spaces are controlled so that LS(i)>LS(i+1) when binary information “0”

are to be embedded, and the line spaces are controlled so that LS(i)<LS(i+1) when binary information “1” are to be embedded. At this time, the line spaces LS(i) and LS(i+1) are assumed to be as follows.

LS(1)=80,LS(2)=70,LS(3)=71,LS(4)=81

In this case, the line-spacing watermark information to be extracted is as follows:

“0” since LS(1)>LS(2), and “1” since LS(3)<LS(4).

As described above, according to the first exemplary embodiment, an appropriate scanning position for extracting line-spacing watermark is determined based on the fluctuations (variance) in the character string heights LT of character-string rectangles and in the line spaces LS in the document image. This prevents erroneous extraction of line-spacing watermarks and enables high-precision extraction.

Note that although the present exemplary embodiment has described an example in which fluctuations are calculated for the character string information LI on a single scanning line and it is determined whether or not the scanned area includes an inappropriate extraction area that can be the cause of erroneous extraction of line-spacing watermark information, the determination method according to the present invention is not limited thereto. For example, character string information LI on multiple scanning lines may be acquired simultaneously and then determination processing may be performed on those multiple scanning lines simultaneously. Alternatively, the character string information LI on a single scanning line may be divided into minimal ranges required for the extraction of watermark information and determination may be performed on each range.

Although the present exemplary embodiment has described the case where, as illustrated in FIG. 4, character string rectangles in a document image are indicated as black pixels and line spaces as white pixels, the present invention is not limited thereto. For example, the present invention is also applicable to other cases such as the case where a document image is negative-positive inverted or the case where character-string rectangles and line spaces are indicated as colored pixels other than black and white pixels.

In the present exemplary embodiment, a document image as illustrated in FIG. 2 in which watermark information has been embedded according to the size of two line spaces has been described as a target to be processed. However, line-spacing watermarks in a document image that can be a target to be processed according to the present invention may be embedded by any other method. For example, the present invention is applicable to any other methods for embedding watermark information by controlling line spaces, such as defining an initial line space as a reference line space and then embedding information sequentially based on the differences of other line spaces from the reference line space.

Moreover, although, in the present exemplary embodiment, a document image that includes only characters as illustrated in FIG. 3 has been described as a target to be processed in order to simplify the description, the present invention is also effective for such a document image that includes illustrations, tables, graphs, or the like, for example.

### Second Exemplary Embodiment

The following describes a second exemplary embodiment of the present invention.

The aforementioned first exemplary embodiment provided an example in which variances are calculated for the character string information that has been obtained by scanning a single area of a document in a sub-scanning direction and then whether or not the scanned area is an inappropriate extraction area is determined. Such a determination method may, however, end up without extracting watermark information if there is any single inappropriate extraction area within a scan. In view of this, in the second exemplary embodiment, multiple areas of a document are scanned in a sub-scanning direction and, in addition, each scan is divided by a predetermined unit so that the character string information is acquired for each divided scanning area (hereinafter referred to as an “extraction unit width”). Specifically, high-precision line-spacing watermark information extraction is allowed by narrowing down the range from which a variance is calculated, specifying target extraction areas that do not include an inappropriate extraction area, and then combining pieces of character string information for those target extraction areas.

Note that the configuration of the document processing apparatus according to the second exemplary embodiment is the same as illustrated in FIG. 1 described in the above first exemplary embodiment, but differs in the operations of the character string information acquisition unit 102 and the character string information determination unit 103. Thus, the following describes only the distinctive operations of the character string information acquisition unit 102 and the character string information determination unit 103 according to the second exemplary embodiment and omits a description of processing performed in the other parts of the configuration.

In the following description of the second exemplary embodiment, a range that includes three character string heights LT and two line spaces LS is assumed to be extracted as the above extraction unit width by a single scan. In addition, at least two scans shall be performed, and the above-described extraction unit width is acquired for each scan.

Note that, in the second exemplary embodiment, the number of pieces of character string information constituting an extraction unit width depends on the size of that extraction unit width. For example, in the case where watermark information has been embedded according to the size of two line spaces as illustrated in FIG. 2, the extraction unit width consists of three character string heights LT and two line spaces LS as described above. The present invention is, however, not limited to this example; it is also possible to, for example, extract an inappropriate extraction area in units of a range that is equivalent to multiples of the extraction unit width.

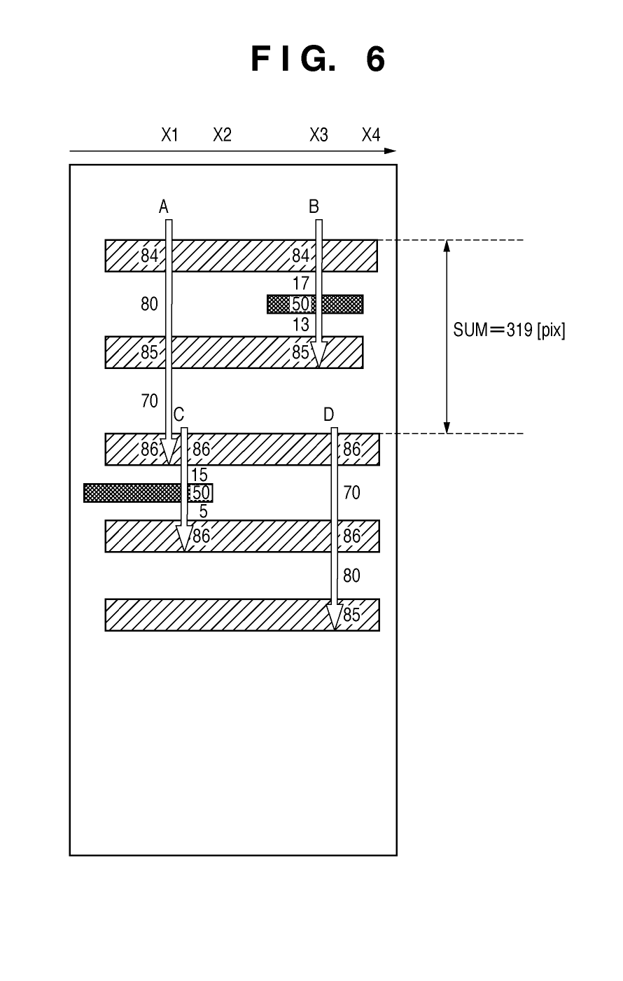

FIG. 6 illustrates the concepts of character string information acquisition according to the second exemplary embodiment. Like FIG. 4 described in the above first exemplary embodiment, FIG. 6 illustrates an example of character-string rectangles in a document image in which character-string rectangles are expressed as black pixels and line spaces as white pixels, and two scans of the rectangular character image shall be performed from each of the starting positions X1 and X3. Specifically, the starting position X1 corresponds to Scans A and C, and the starting position X3 corresponds to Scans B and D. Each Scan A, B, C, or D corresponds to the extraction unit width in the second exemplary embodiment; although they have varying lengths in the sub-scanning direction, they each include three character string heights LT and two line spaces LS.

In the example illustrated in FIG. 6, the character string information acquisition unit 102 obtains, as the character string information LI, the character string heights LT and the line spaces LS as follows using Scans A and B as a first extraction unit width. Note that LT and LS are expressed in units of pixels.

Scan A: LT(1)=84, LT(2)=85, LT(3)=86

LS(1)=80, LS(2)=70;

Scan B: LT(1)=84, LT(2)=50, LT(3)=85

LS(1)=17, LS(2)=13

Then, as in the first exemplary embodiment, the character string information determination unit 103 calculates a variance for each scan from the expression (1) and determines whether or not each scan includes an inappropriate extraction area. In this case, the variances in Lt and LS for Scan A are calculated at 0.7 and 25.0, respectively, and the variances in LT and LS for Scan B are calculated at 264.7 and 4.0, respectively. If T=30, Scan A is determined as not including an inappropriate extraction area, whereas Scan B is determined as including an inappropriate extraction area (dotted area in the drawing). Thereafter, the character string information determination unit 103 transmits the results of the determination and a sum total SUM of the values LT and LS for the scan A to the character string information acquisition unit 102.

Note that since the value SUM is used in setting a starting position for scans using the next extraction unit width, the last LT (in the case of Scan A, LT(3)) for the current extraction unit width is excluded from a target sum total. In other words, in the example of FIG. 6, the value SUM for Scan A is a total value of LT(1)=84, LT(2)=85, LS(1)=80, and LS(2)=70, i.e., SUM=319.

Upon receiving the result of the determination and the SUM from the character string information determination unit 103, then the character string information acquisition unit 102 sets a starting position for the next scan using a second extraction unit width. In the example of FIG. 6, the second extraction unit width is set at the positions that are at X1 and X3 in the main scanning direction and that are at any value after the SUM of 319 in the sub-scanning direction, that is, at the starting positions of Scans C and D. Thereafter, the character string information LI is acquired by Scans C and D and the obtained information is transmitted to the character string information determination unit 103. Note that the starting positions in the main scanning direction are not limited to the same positions X1 and X3 as in the previous scan and may be changed to other positions, for example, the positions X2 and X4 as illustrated in FIG. 6.

As in the case of Scans A and B, the character string information determination unit 103 also determines whether or not each of Scans C and D includes an inappropriate extraction area based on the acquired character string information LI.

According to the example illustrated in FIG. 6, since the main scanning starting positions are X1 and X3 and SUM=319, the following values LT and LS are obtained as the character string information LI by each scan:

Scan C: LT(1)=86,LT(2)=50,LT(3)=86

LS(1)=15,LS(2)=5

Scan D: LT(1)=86,LT(2)=86,LT(3)=85

LS(1)=70,LS(2)=80

In this case, from the expression (1), the variances in LT and LS for Scan C are calculated at 288.0 and 25, respectively, and the variances in LT and LS for Scan D are calculated at 0.2 and 25, respectively. Since T=30, Scan C is determined as including an inappropriate extraction area (dotted area in the drawing), and Scan D is determined as not including an inappropriate extraction area.

In the example illustrated in FIG. 6, all scanning has been completed through Scans A and B that correspond to the first extraction unit width, and Scans C and D that correspond to the second extraction unit width. Thereafter, the character string information determination unit 103 combines pieces of character string information that have been obtained by the scans whose variances are lower than the threshold value, that is, by the scans of target extraction areas. In the preset case, Scans A and D correspond to such scans; accordingly, the result of the combination of those pieces of character string information LI is as follows.

LT(1)=84,LT(2)=85,LT(3)=86,LT(4)=86,LT(5)=85

LS(1)=80,LS(2)=70,LS(3)=70,LS(4)=80

The character string information LI that has been combined as described above is transmitted to the watermark information extraction unit 104 and from then on, line-spacing watermark information is extracted as described above in the first exemplary embodiment.

Note that, in the second exemplary embodiment, if no scan for a certain extraction unit width has obtained variances lower than the threshold value, that is, if all scans have been determined as including an inappropriate extraction area, some measures are taken such as changing a scan starting position or increasing the number of areas to be scanned for the extraction unit width. And yet, if no target extraction area has been detected for that extraction unit width, it is determined that the extraction of watermark information using that extraction unit width is impossible. In that case, a predetermined value is set as the SUM and the presence or absence of an inappropriate extraction area is verified for a new extraction unit width after that SUM.

On the other hand, if multiple scans for a certain extraction unit width have obtained variances lower than the threshold value, any one of them may be selected. For example, a scan with a minimum variance may be selected.

As described above, according to the second exemplary embodiment, the range of a document from which variances are calculated is divided and set as extraction unit widths. This enables target extraction areas to be specified and combined for each extraction unit width, thus enabling more precise extraction of line-spacing watermark information than in the first exemplary embodiment.

### Third Exemplary Embodiment

The following describes a third exemplary embodiment of the present invention.

In the first and second exemplary embodiments described above, at the time of generating a rectangular image IR, character-string rectangles are generated by sequentially scanning image data I from the top end and then specifying the boundaries between black and white pixels. This method, however, requires scanning of the entire image data I, thus increasing processing time. For example, in a case where information embedded in image data I is copy control information, copy processing can be performed after extracting the embedded information by a scan of the entire image in a copying machine and then determining whether or not copying is available from the extracted information; this requires a considerable amount of time for the copying of a single sheet of a document.

In view of this, the third exemplary embodiment has the feature that a rectangular image IR in which a single line represents a single object is generated by reducing image data I in the main scanning direction so as to reduce the time required for generating the rectangular image IR.

Note that the configuration of a document processing apparatus according to the third exemplary embodiment is the same as illustrated in FIG. 1 described in the above first exemplary embodiment, but differs in the operations of the character string information acquisition unit 102. Thus, the following describes only the distinctive operations of the character string information acquisition unit 102 according to the third exemplary embodiment and omits a description of processing performed in the other parts of the configuration.

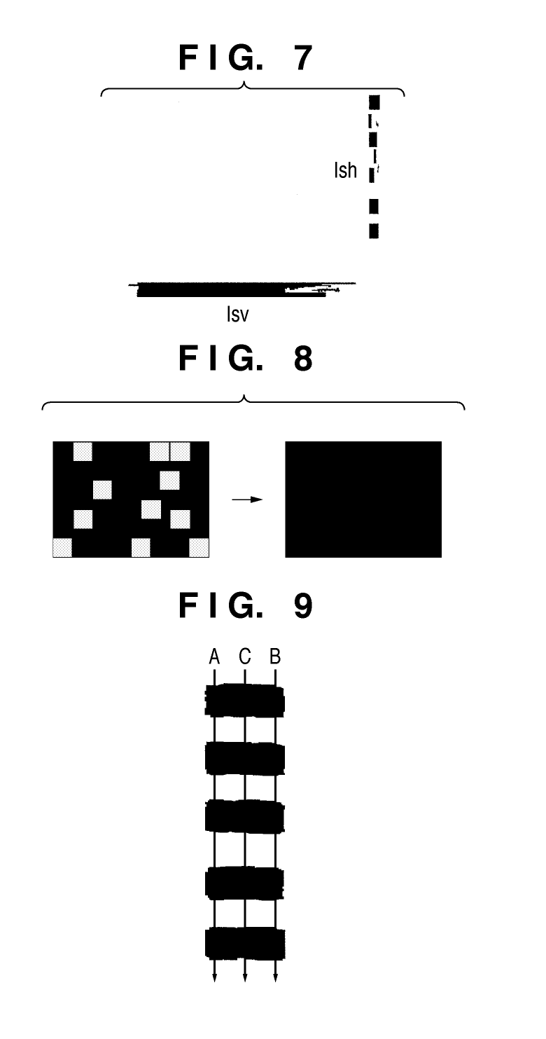

The character string information acquisition unit 102 horizontally and vertically reduces image data I transmitted from the image input unit 101 so as to generate horizontally reduced image data Ish and vertically reduced image data Isv. FIG. 7 illustrates an example of such horizontally reduced image data Ish and vertically reduced image data Isv generated from the image data I illustrated in FIG. 3.

Note that the reason for reducing the image data I both horizontally and vertically is because it is uncertain in which direction the image data I has been input, that is, which direction the line spacing is in is uncertain since the main scanning direction is uncertain, such as the case of a 90-degree angled image. It is of course possible to reduce the image data I only in either direction, horizontally or vertically, if the direction of input can be specified.

In the example illustrated in FIG. 7, the horizontally reduced Ish is effective. That is, in the third exemplary embodiment, by reducing the image data I, a single line is reduced into a single object as illustrated by Ish in FIG. 7, that is, a single character-string rectangle is recognized in each line, which enables high-speed extraction of a line-spacing watermark. Note that the reduction of image data I according to the third exemplary embodiment is performed at such a level that character-string rectangles are recognizable.

Which of the reduced image data Ish or Isv in FIG. 7 should be made effective, that is, from which reduced image data the watermark information should be extracted, is determined by, for example, performing test scans on both data and selecting the one from which line space values or the like have been obtained.

Now, for example if a bilinear method in which image data I is reduced by calculating a pixel value at a certain point from pixel values at four grid points surrounding the certain point is employed as the reduction method, a resultant reduced image includes half-tone portions (expressed by gray in the drawing) that are neither white nor black pixels, as illustrated in FIG. 8. In such a case, those half-tone portions are converted into black pixels. Note that the reduction method according to the third exemplary embodiment is not limited to a bilinear method but may be any of various reduction methods such as the nearest neighbor method or the bi-cubic method.

In the third exemplary embodiment, the character string information LI is acquired from such generated reduced image data Ish or Isv. Note that the method for acquiring the character string information LI is the same as described above in the first and second exemplary embodiments, so the description thereof will be omitted.

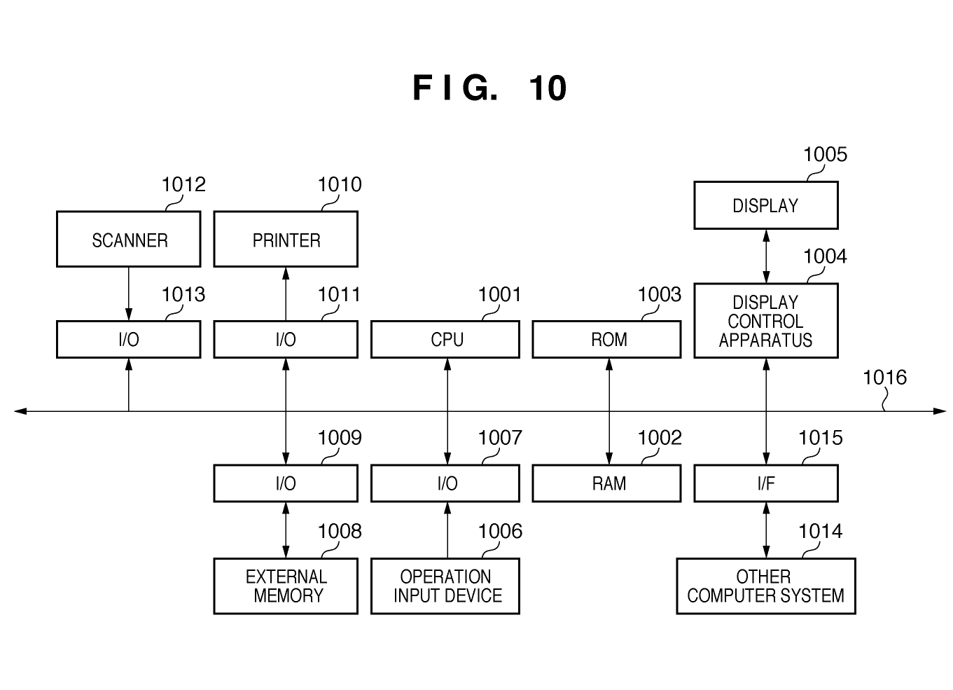

Note that the rectangular image IR (in the preset example, Ish) generated by reducing the image data I includes areas where line spaces slightly vary as illustrated in FIG. 9. Thus, in order to further increase the precision of extraction, the character string information may be acquired by multiple scans. Then, in a case where appropriate character string information has been acquired by multiple scans, the line-spacing watermark information may be extracted for each scan and, based the majority, the most frequently extracted line-spacing watermark information may be detected.

As described above, the third exemplary embodiment can shorten the time required to extract line-spacing watermark information by reducing image data I to generate a rectangular image IR.

### Fourth Exemplary Embodiment

The following describes a fourth exemplary embodiment according to the present invention. The fourth exemplary embodiment has the feature that it causes a computer system to perform the processing described above in the first to third exemplary embodiments.

FIG. 10 is a block diagram illustrating a basic configuration of a computer system according to the fourth exemplary embodiment. In order for this computer system to execute all the functions described in the aforementioned exemplary embodiments, each functional configuration is described in a program and the computer system reads that program.

In FIG. 10, reference numeral 1001 denotes a CPU that controls the entire system using programs or data stored in a RAM 1002 or a ROM 1003 as well as performing the processing described in the aforementioned exemplary embodiments. Reference numeral 1002 denotes a RAM that includes an area in which programs or data that have been loaded from an external memory 1008 or that have been downloaded from the other computer system 1014 over an I/F (interface) 1015 are temporarily stored. The RAM 1002 also includes a working area required for the CPU 1001 to perform various processes. Reference numeral 1003 denotes a ROM that stores functional programs, settings data, and the like that are used in a computer system.

Reference numeral 1004 denotes a display control apparatus that performs control for causing a display 1005 to display images, characters, or the like. Reference numeral 1005 denotes a display that displays images, characters, or the like. Note that the display 1005 may be a cathode-ray tube, a liquid crystal screen, or the like, for example. Reference numeral 1006 denotes an operation input device that consists of any device such as a keyboard or a mouse that can input various user instructions into the CPU 1001. Reference numeral 1007 denotes an I/O that communicates various instructions or the like that have been input with the operation input device 1006 to the CPU 1001. Reference numeral 1008 denotes an external memory that serves as a mass storage information device such as a hard disk, and stores an OS (operating system) or programs for causing the CPU 1001 to execute the processing described in the above exemplary embodiments, input and output original images, and the like. The writing of information to the external memory 1008 or the reading of information from the external memory 1008 are performed through an I/O 1009.

Reference numeral 1010 denotes a printer for printing and outputting a document or an image, and its output data is transmitted through an I/O 1011 from the RAM 1002 or the external memory 1008. Note that the printer 1010 may be an inkjet printer, a laser beam printer, a thermal transfer printer, or a dot-impact printer, for example. Reference numeral 1012 denotes a scanner for reading a document or an image, and its input data is transmitted through an I/O 1013 to the RAM 1002 or the external memory 1008. Reference numeral 1016 denotes a bus that connects the CPU 1001, the ROM 1003, the RAM 1002, the I/O 1011, the I/O 1009, the display control apparatus 1004, the I/F 1015, the I/O 1007, and the I/O 1013.

As described above, according to the fourth exemplary embodiment, the line-spacing watermark information detection processing described in the aforementioned first to third exemplary embodiments can be realized by a computer system. Note that, while the fourth exemplary embodiment provides an example in which the program for realizing the functions of the above-described first to third exemplary embodiments is prepared and executed under the control of the CPU 1001, some functions may be realized by a dedicated hardware circuit or the like. Such a dedicated hardware circuit may be a device such as the scanner 1012 or the printer 1010 that is provided in an external apparatus.

Note that the foregoing embodiment merely illustrates a specific example for implementing the invention, and the technical scope of the invention is not to be construed restrictively as a result of this embodiment. That is, the invention can be implemented in various forms without departing from the technical idea or main features thereof.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-274868 filed on Oct. 24, 2008, which is hereby incorporated by reference herein in its entirety.

What is claimed is:

1. A document processing apparatus that extracts line-spacing watermark information that has been embedded by the use of line spacing from a document image, comprising:
an input unit adapted to input a document image;
a character string information acquisition unit adapted to acquire a character string height and a line spacing value as character string information on the document image;
a fluctuation calculation unit adapted to calculate fluctuations in the character string height and fluctuations in the line spacing value;
a character string information determination unit adapted to determine whether or not the character string information is appropriate for use in extracting line-spacing watermark information, based on values of the fluctuations calculated by the fluctuation calculation unit; and
a watermark information extraction unit adapted to extract line-spacing watermark information from the character string information when the character string information determination unit has determined the character string information as being appropriate.

2. The document processing apparatus according to claim 1, wherein the character string information determination unit determines whether or not the character string information is appropriate by comparing the values of the fluctuations in the character string height and in the line spacing value calculated by the fluctuation calculation unit, with a prescribed threshold value.

3. The document processing apparatus according to claim 1, wherein, when the character string information determination unit has determined the character string information as being inappropriate, the character string information acquisition unit sets a starting position of a next character string information acquisition area in the document image.

4. The document processing apparatus according to claim 1, wherein
the character string information acquisition unit acquires the character string information from a plurality of areas in the document image, and
based on the values of the fluctuations calculated by the fluctuation calculation unit for a plurality of pieces of character string information, the character string information determination unit selects an appropriate piece of character string information for use in extracting line-spacing watermark information from among the plurality of pieces of character string information.

5. The document processing apparatus according to claim 4, wherein the character string information acquisition unit acquires the character string information from a plurality of areas with a plurality of sub-scans of the document image.

6. The document processing apparatus according to claim 4, wherein the character string information acquisition unit divides a sub-scan of the document image into a predetermined extraction unit widths, and acquires the character string information for each of the extraction unit widths.

7. The document processing apparatus according to claim 6, wherein
the character string information determination unit determines whether or not each piece of character string information that has been acquired for each extraction unit width by the character string information acquisition unit is appropriate, and combines pieces of character string information that have been determined as being appropriate, for the extraction unit width, and
the watermark information extraction unit extracts line-spacing watermark information from the combined pieces of character string information obtained from the character string information determination unit.

8. The document processing apparatus according to claim 6, wherein the character string information acquisition unit acquires the character string information, using as the extraction unit width a range that includes a predetermined number of character string heights and a predetermined number of line spacing values.

9. The document processing apparatus according to claim 1, wherein the character string information acquisition unit acquires the character string information from an image obtained by reducing the document image in a main scanning direction.

10. The document processing apparatus according to claim 1, wherein the character string information acquisition unit creates a rectangular character string image for the document image and based on the rectangular character string image, acquires a character string height and a line spacing value as the character string information.

11. The document processing apparatus according to claim 1, wherein the fluctuation calculation unit calculates a variance as fluctuations.

12. The document processing apparatus according to claim 1, wherein the fluctuation calculation unit calculates a deviation or standard deviation as fluctuations.

13. A document processing method for extracting line-spacing watermark information embedded by use of line spacing from a document image, comprising:
an input step of inputting a document image;
a character string information acquisition step of acquiring a character string height and a line spacing value as character string information on the document image;
a fluctuation calculation step of calculating fluctuations in the character string height and fluctuations in the line spacing value;
a character string information determination step of determining whether or not the character string information is appropriate for use in extracting line-spacing watermark information, based on values of the fluctuations calculated in the fluctuation calculation step; and
a watermark information extraction step of extracting line-spacing watermark information from the character string information when the character string information has been determined as being appropriate in the character string information determination step.

14. A computer-readable recording medium that stores a program for causing a computer to execute document processing for extracting line-spacing watermark information embedded by use of line spacing from a document image,
the program causing the computer to serve as:
an input unit that inputs a document image;
a character string information acquisition unit that acquires a character string height and a line spacing value as character string information on the document image;
a fluctuation calculation unit that calculates fluctuations in the character string height and fluctuations in the line spacing value;
a character string information determination unit that determines whether or not the character string information is appropriate for use in extracting line-spacing watermark information, based on values of the fluctuations calculated by the fluctuation calculation unit; and
a watermark information extraction unit that extracts line-spacing watermark information from the character string information when the character string information determination unit has determined the character string information as being appropriate.
